(19) United States
(12) Patent Application Publication
(10) Pub. No.: US 2023/0118229 A1
(43) Pub. Date: Apr. 20, 2023

(54) PARCEL MERGING AND ALIGNMENT USING DIVERTING SHOES

(71) Applicant: Körber Supply Chain LLC, DFW Airport, TX (US)

(72) Inventor: Manish Sthapit, Irving, TX (US)

(21) Appl. No.: 17/906,993

(22) PCT Filed: Apr. 26, 2021
(86) PCT No.: PCT/US2021/029044

§ 371 Date: Sep. 22, 2022

Related U.S. Application Data
(60) Provisional application No. 63/027,119, filed on May 19, 2020.

(51) Int. Cl. B65G 47/84; B65G 43/08; B65G 47/24

(52) U.S. Cl. CPC B65G 47/844; B65G 43/08; B65G 47/24; B65G 2201/0285

(57) ABSTRACT

A parcel processing system (100, 200) includes a merge and align conveyor (102, 202) to transport parcels (108, 208) received at an input end to a discharge end thereof, along a conveying direction (116, 216). The merge and align conveyor (102, 202) includes a link conveyor, wherein the link elements (110, 210) extend longitudinally transverse to the conveying direction (116, 216). A plurality of shoes (112, 212) are provided, each shoe (112, 212) mounted individually on a respective link element (110, 210) and configured to be moved longitudinally along the respective link element (110, 210) while being moved in the conveying direction (116, 216) together with the respective link element (110, 210). The shoes (112, 212) are independently controllable to divert at least a subset of the parcels (108, 208) received at the input end transversely to the conveying direction (116, 216) and stop at a fixed line (122, 222) between opposite edges (130-132, 230-232) of the merge and align conveyor (102, 202). Thereby, a a substantially single file parcel flow exiting the discharge end of the merge and align conveyor (102,202) is obtained along the fixed line (122,222).

### CROSS REFERENCE TO RELATED APPLICATIONS

This application claims priority to the U.S. Provisional Application No. 63/027,119 filed May 19, 2020, which is incorporated by reference herein in its entirety.

### TECHNICAL FIELD

The present disclosure relates generally to the field of mail and parcel processing, and in particular to a technique for merging and aligning parcels.

### BACKGROUND

Parcel distribution centers typically receive large quantities of parcels or packages, often widely varying in size, that are unloaded en masse from trucks or other transportation media. The packages merge into a central area in a random order and orientation where they are oriented and aligned in a single file by singulators for further processing. The further processing may include, for example, scanning of destination-identifying bar codes and sortation to destination areas for loading onto trucks or other transportation media.

### SUMMARY

A first aspect of the disclosure sets forth a parcel processing system. The parcel processing system comprises a merge and align conveyor configured to transport parcels received at an input end to a discharge end of the merge and align conveyor. The merge and align conveyor comprises a support surface for conveying the parcels, which is formed by a plurality of successively arranged link elements configured to be driven along a conveying direction from the input end to the output end. The link elements extend longitudinally transverse to the conveying direction. The merge and align conveyor further comprises a plurality of shoes. Each shoe is mounted individually on a respective link element and configured to be moved longitudinally along the respective link element while being moved in the conveying direction together with the respective link element. The shoes are independently controllable to divert at least a subset of the parcels received at the input end transversely to the conveying direction and stop at a fixed line between opposite edges of the merge and align conveyor, whereby a substantially single file parcel flow exiting the discharge end of the merge and align conveyor is obtained along the fixed line.

A second aspect of the disclosure sets forth a parcel processing method. The method comprises receiving parcels at an input end of a merge and align conveyor and transporting parcels on the merge and align conveyor from the input end to a discharge end thereof. The merge and align conveyor comprises a support surface for conveying the parcels, which is formed by a plurality of successively arranged link elements configured to be driven along a conveying direction from the input end to the output end. The link elements extend longitudinally transverse to the conveying direction. The method further comprises diverting at least a subset of the parcels received at the input end transversely to the conveying direction by a plurality of shoes. Each shoe is mounted individually on a respective link element and configured to be moved longitudinally along the respective link element while being moved in the conveying direction together with the respective link element. The method comprises independently controlling each shoe to divert said at least a subset of the parcels received at the input end transversely to the conveying direction and stop at a fixed line between opposite edges of the merge and align conveyor, whereby a substantially single file parcel flow exiting the discharge end of the merge and align conveyor is obtained along the fixed line.

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1 is a simplified schematic diagram illustrating portion of a parcel processing system according to a first embodiment employing diverting shoes for merging and aligning parcels.

FIG. 2 is a simplified schematic diagram illustrating portion of a parcel processing system according to a second embodiment employing diverting shoes for merging and aligning parcels that rejects non-conveyable parcels.

FIG. 3 illustrates a block diagram of a data processing system with which an embodiment can be implemented.

### DETAILED DESCRIPTION

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Parcel processing systems generally utilize angled roller conveyors to converge parcels into a single file and align the parcels along their length. For example, a typical parcel singulation system includes a merge conveyor that converges a two-dimensional stream of parcels into a single file, followed by an aligner conveyor that aligns the converged stream of parcels against a wall to correct rotation. To recover from potential errors in gapping between parcels introduced by the roller conveyors (particularly with smaller parcels), a gap correction system may be disposed downstream of the singulation system. In some configurations, an exception handling system may be disposed downstream of the singulation system to divert the flow of exceptional or rejected parcels to a specified direction for separate handling. Rejected parcels may include parcels that cannot be sent to a sorter, for example, overlapped parcels (especially applicable for small parcels), parcels that are not completely singulated, non-conveyables, among others.

Aspects of the present disclosure provide an alternative solution to the above-described singulation method. Specifically, the embodiments described below employ diverting shoes to merge and align parcels instead of relying on roller conveyors for the same purpose. Embodiments of the disclosure may find application in a parcel singulation system (as illustrated herein), as well as other applications that require parcels/cartons to be aligned.

To facilitate understanding of the various views shown in the drawings, reference may be made to the mutually orthogonal X, Y, and Z axes that are consistently defined in the drawings.

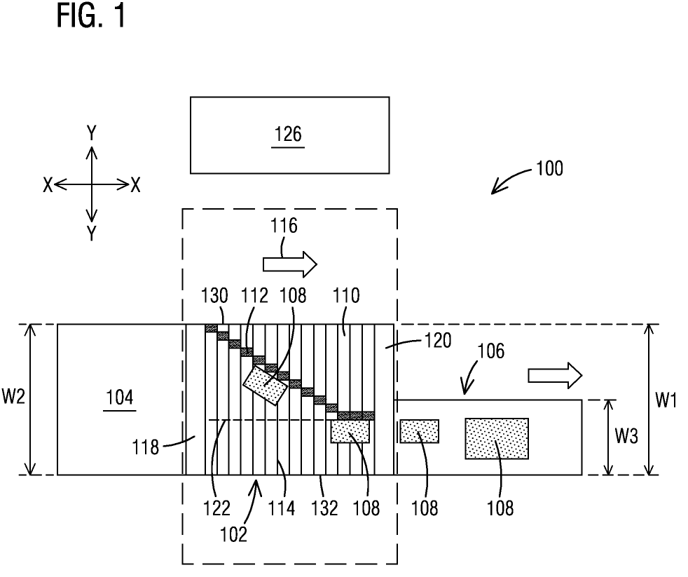

FIG. 1 illustrates a parcel processing system 100 according to a first embodiment. The parcel processing system 100 comprises a merge and align conveyor 102, an upstream singulation device 104 and a takeaway conveyor 106. The upstream singulation device 104 delivers parcels 108 at an input end of the merge and align conveyor 102. The takeaway conveyor 106 receives parcels 108 from a discharge end of the merge and align conveyor 102 and transports the parcels 108 for subsequent processing, such as parcel sorting.

The portion of the parcel processing system 100 within the dashed box in FIG. 1 may replace a roller merge/aligner combination as described above.

The upstream singulation device 104 may be configured to deliver a parcel flow with precise gapping (spacing between parcels in the X-X direction) to the input end of the merge and align conveyor 102. In one embodiment, the upstream singulation device 104 may comprise one or more transport accumulators with metered discharge, as disclosed in the International Patent Application Publication No. WO 2020219044 A1, filed by the present Applicant, the content of which is incorporated by reference herein in its entirety. The parcel flow at the input end of the merge and align conveyor 102 typically comprises a two-dimensional queue of parcels 108 (with spacing in both X-X and Y-Y directions) with metered gapping in the X-X direction. As described in greater detail below, the parcel flow at the discharge end of the merge and align conveyor 102 comprises a substantially one-dimensional queue (spacing in X-X direction only) of parcels 108 delivered to the takeaway conveyor 106. The takeaway conveyor 106 may comprise, for example, a belt conveyor.

The merge and align conveyor 102 comprises a link conveyor having a support surface for conveying the parcels 108 that is formed by a plurality of successively arranged link elements 110 (e.g., slats). The link elements 110 may form a chain driven loop. The chain may be driven by a motor (not shown), which causes the link elements 110 to cycle, similar to a belt conveyor. The link elements 110 are configured to be driven along a conveying direction 116 from the input end to the output end of the merge and align conveyor 102. In the figure, the conveying direction 116 is parallel to the X-axis. The link elements 110 extend longitudinally transverse to (i.e., across) the conveying direction 116. In this example, the link elements 110 extend longitudinally perpendicular to the conveying direction 116, i.e., parallel to the Y-Y direction. Every link element 110 is provided with a push-off element 112, referred to herein as a “shoe”. Each shoe 112 is mounted individually on a respective link element 110 and is movable longitudinally along the respective link element 110, while being moved together with the link element 110 along the conveying direction 116. Each shoe 112 may have its own drive element (not shown) which may be independently controlled, allowing each shoe 112 to be moved and stopped independently.

Each shoe 112 may be engageable on a guide mechanism (such as a rail positioned underneath the support surface) which guides the shoe 112 longitudinally along the respective link element 110. In other embodiments, each shoe 112 may extend through and move within slots 114 between adjacent link elements 110. The drive elements may comprise any type of drive mechanism. In one embodiment, each drive element may comprise a linear motor comprising a spindle that moves the shoe 112 when rotated. The shoes 112 are controllable (via the drive elements) to divert each of the parcels 108 received at the input end transversely in relation to the conveying direction 116, and stop at a fixed distance along the link elements 110 as measured from a lateral edge 130, 132 of the merge and align conveyor 102. In FIG. 1, the position at which the diverting shoes 112 stop the parcels 108 is shown by the line 122. The line 122 (which could be an imaginary line) has a fixed position located between opposite edges 130, 132 of the merge and align conveyor 102.

A control system 126 controls the operation of the parcel processing system 100. In one embodiment, the control system 126 may include one or more controllers (e.g., programmable logic controllers) capable of controlling individual devices (e.g., the merge and align conveyor 102, the diverting shoes 112, the upstream singulation device 104, the takeaway conveyor 106, etc.) in a manner as described herein. The control system 126 may additionally comprise a computer system capable for coordinating the overall operation of the parcel processing system based on the assignment of sorting destinations to the output bins. Control elements such as sensors, actuators, motors, encoders (for tracking parcels on conveyors/sorters), barcode scanners, intermediate I/O systems used for aggregation and distribution of input and output signals may also be considered to be part of the overall control system.

The merge and align conveyor 102 has a width W1 which is greater than or equal to a width W2 of the upstream singulation device 104. The takeaway conveyor 106 has a width W3 which is lesser than the width W2 of the upstream singulation device 104. The merge and align conveyor 102 spans widthwise over the widths of the upstream singulation device 104 and the takeaway conveyor 106. As shown in FIG. 1, the widths W1, W2 and W3 are measured parallel to the Y-axis. The diverting shoes 112 are configured to stop when the parcels 108 are within the width of the takeaway conveyor 106, as shown by the position of the line 122. This results in an essentially single file parcel flow (i.e., with spacing in the X-X direction only) exiting the discharge end of the merge and align conveyor 102 along the line 122. The takeaway conveyor 106 is positioned such that the line 122 is located within the width W3 of the takeaway conveyor 106.

In the embodiment shown in FIG. 1, the diverting shoes 112 are arranged in an angled configuration. Herein, multiple shoes 112 are arranged at various positions along the length of the respective link elements 110 such that a line of shoes 112 makes an angle (e.g., about 20 degrees) to the conveying direction 116. After a parcel 108 enters the merge and align conveyor 102, a determined number of shoes 112 are actuated at a determined point in time. The actuated shoes 112 impact the parcel 108 desirably at a low speed, to retain contact with the parcel 108. The actuated shoes 112 then push the parcel 108 to a region of the merge and align conveyor 102 which overlaps widthwise with the takeaway conveyor 106. The shoes 112 have push faces (i.e., faces which contact the parcel 108) that are parallel to the conveying direction 116. The parcel 108 retains its orientation as it traverses the link element 110. Each shoe 112 stops precisely at the line 122 with the respective push-faces along a straight line, ensuring the parcel 108 is aligned lengthwise (i.e., oriented by length) along the line 122 by the pushing action of the shoes 112. The stopping point of the shoes 112 may be mechanically configurable to accommodate various takeaway conveyor 106 widths (e.g., for large parcel, smalls or mixed parcel singulators).

For a given parcel 108, the number of shoes 112 required to divert the parcel 108 and the timing for actuating the shoes 112 may be determined by the control system 126 based on the length of the parcel and the parcel gapping respectively. The parcel length and gapping may be dimensioned by a sensor, such as a single dimensional photo eye, a 2D or a 3D camera, among others. The parcel dimensioning sensor may be incorporated, for example, in the upstream singulation device 104, or at any other suitable location.

The embodiment shown in FIG. 1 further comprises a first transition conveyor belt 118 for transitioning parcels 108 from the upstream singulation device 104 to the merge and align conveyor 102, and a second transition conveyor belt 120 for transitioning parcels 108 from the merge and align conveyor 102 to the takeaway conveyor 106. The transition conveyor belts 118, 120 are powered belts and which may serve to close gaps created because of sorter sprocket circumference. The transition conveyor belts 118, 120 may include, for example, knife-edge conveyor belts.

The width (X dimension) of the link elements 110 define the ability of the merge and align conveyor 102 to handle the gapping (X-X spacing) between parcels 108 coming out of the upstream singulation device 104. For example, having smaller link element widths increases the system’s ability to handle smaller parcel gapping from the upstream singulation device 104.

The length (Y dimension) of the link elements 110 may cover the entire width W2 of the upstream singulation device 104 to accommodate parcels 108 exiting the extreme ends along the width of the upstream singulation device 104 output. Note that the bottommost parcel 108 in the takeaway conveyor 106 was not required to be diverted by the shoes 112 since it was received from an extreme end of the upstream singulation device 104 output.

The length (X dimension) of the merge and align conveyor 102 may be determined based on the width W3 of the takeaway conveyor 106 and on the lengths (X dimension) of the transition conveyor belts 118, 120. In addition, the width (W1- W3) of the transition zone of the link elements 110, along with the maximum speed that the shoe 112 can travel according to the stability of parcels 108 being contacted and pushed along the link element 110 by the shoe 112, is an important factor in the determination of the length of the merge and align conveyor 102. The progress of consecutive shoes movement along the link elements 110 may describe the hypotenuse of a triangle converging with the base, which forms the x-axis in the direction of travel of the merge and align conveyor 102. The angle of the hypotenuse is proportional to the speed of the shoes 112 during operation, therefore a constraint in the speed establishes a second constant to the width, in turn prescribing the minimum length.

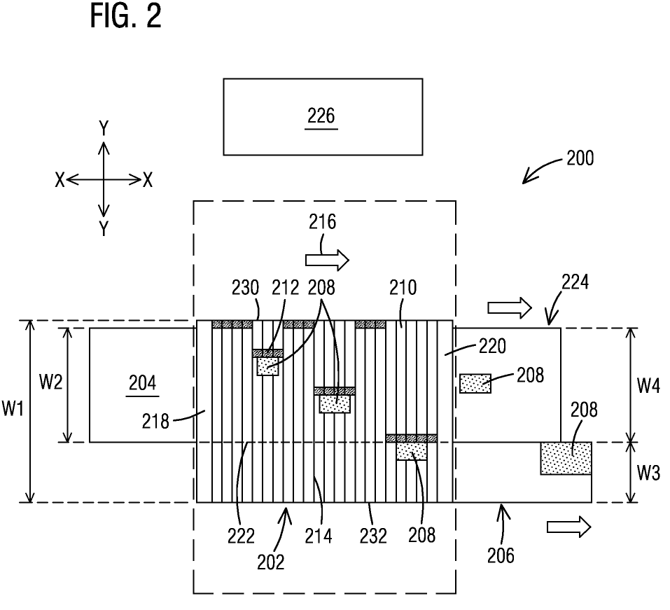

FIG. 2 illustrates a parcel processing system 200 according to a second embodiment. In FIG. 2, like elements in relation FIG. 1 are indicated by reference numbers that differ only in the most significant digit from the corresponding reference number in FIG. 1.

The parcel processing system 200 comprises a merge and align conveyor 202, an upstream singulation device 204, a takeaway conveyor 206 and a reject conveyor 224. The upstream singulation device 204 delivers parcels 208 at an input end of the merge and align conveyor 202. The takeaway conveyor 206 receives regular or non-rejected parcels 208 (i.e., parcels that can be sent to a sorter) from a discharge end of the merge and align conveyor 202. The reject conveyor 224 receives exceptional or rejected parcels 208 from the discharge end of the merge and align conveyor 202.

The portion of the parcel processing system 200 within the dashed box in FIG. 2 may replace a roller merge/aligner combination and might further obviate the requirement for a downstream exception handling system as described above.

As in the previous embodiment, the upstream singulation device 204 may be configured to deliver a parcel flow with precise gapping (spacing between parcels in the X-X direction) to the input end of the merge and align conveyor 202. The parcel flow at the input end of the merge and align conveyor 202 typically comprises a two-dimensional queue of parcels 208 (with spacing in both X-X and Y-Y directions) with metered gapping in the X-X direction.

The merge and align conveyor 202 comprises a link conveyor similar having a support surface for conveying the parcels 208 that is formed by a plurality of successively arranged link elements 210. The link conveyor of FIG. 2 may have a similar construction and operation as the link conveyor shown in FIG. 1. As parcels 208 are transported along the merge and align conveyor 202, regular parcels 208 are pushed into a single file by the action of diverting shoes 212 and transferred at the discharge end to the takeaway conveyor 206 in a substantially one-dimensional queue (spacing in X-X direction only). The parcels 208 that are identified as rejected are not impacted by the diverting shoes 212 and travel substantially un-diverted to the discharge end where they are transferred to the reject conveyor 224. Parcels that are identified as rejected may include parcels that cannot be sent to a sorter, for example, overlapped parcels (especially applicable for small parcels), parcels that are not completely singulated, non-conveyables, among others. Thus, in the embodiment shown in FIG. 2, a subset of parcels 208 (regular parcels) received at the input end of the merge and align conveyor 202 are selectively transferred in a single file to discharge end. The takeaway conveyor 206 and the reject conveyor 224 may comprise, for example, belt conveyors.

Every link element 210 is provided with a push-off element 212 or “shoe”. Each shoe 212 is mounted individually on a respective link element 210 and is movable longitudinally along the respective link element 210, while being moved together with the link element 210 along the conveying direction 216. Each shoe 212 may have its own drive element (not shown) which may be independently controlled, allowing each shoe 212 to be moved and stopped independently. Each shoe 212 may be engageable on a guide mechanism (such as a rail positioned underneath the support surface) which guides the shoe 212 longitudinally along the respective link element 210. In one embodiment, each drive element may comprise a linear motor comprising a spindle that moves the shoe 212 when rotated. A construction of diverting shoes that is particularly suitable for the present embodiment is described in the Internal Application Publication No. WO 2021037610 A1.

The shoes 212 are controllable (via the drive elements) to divert only the regular or non-rejected parcels 208 transversely in relation to the conveying direction 216, and stop at a fixed distance along the link elements 210 as measured from a lateral edge 230, 232 of the merge and align conveyor 202. The position at which the diverting shoes 212 stop the regular parcels 208 is shown by the line 222. The line 222 (which could be an imaginary line) has a fixed position located between opposite edges 230, 232 of the merge and align conveyor 202. The takeaway conveyor 206 is positioned such that the line 222 is located within the width W3 of the takeaway conveyor 206. As shown in FIG. 2, the diverting shoes 212 stop when the parcel 208 is within the width of the takeaway conveyor 206. The stopping point of the shoes 212 may be mechanically configurable to accommodate various takeaway conveyor 206 widths (e.g., for large parcel, smalls or mixed parcel singulators).

A control system 226 controls the operation of the parcel processing system 200. In one embodiment, the control system 226 may include one or more controllers (e.g., programmable logic controllers) capable of controlling individual devices (e.g., the merge and align conveyor 202, the diverting shoes 212, the upstream singulation device 204, the takeaway conveyor 206, the reject conveyor 224, etc.) in a manner as described herein. The control system 226 may additionally comprise a computer system capable for coordinating the overall operation of the parcel processing system based on the assignment of sorting destinations to the output bins. Control elements such as sensors, actuators, motors, encoders (for tracking parcels on conveyors/sorters), barcode scanners, intermediate I/O systems used for aggregation and distribution of input and output signals may also be considered to be part of the overall control system.

In the embodiment shown in FIG. 2, the diverting shoes 212 are arranged in a parallel configuration. Herein, the shoes 212 on respective link elements are arranged along an edge 230 of the merge and align conveyor 202, such that a line of shoes 212 is parallel to the conveying direction 216. After a parcel 208 enters the merge and align conveyor 202, a determined number of shoes 212 are actuated at a determined point in time. The actuated shoes 212 impact the parcel 208 at a desirably low speed, to retain contact with the parcel 208. The actuated shoes 212 then push the parcel 208 to a region of the merge and align conveyor 202 which overlaps widthwise with the takeaway conveyor 206. The shoes 212 have push faces (i.e., faces which contact the parcel 208) that are parallel to the conveying direction 216. The parcel 208 retains its orientation as it traverses the link element 210. Each shoe 212 stops precisely at the line 222 with the respective push-faces along a straight line, ensuring the parcel 208 is aligned lengthwise (i.e., oriented by length) along the line 222 by the pushing action of the shoes 212.

A parallel configuration of the diverting shoe 212 may be more effective to prevent rejected parcels 208 from being impacted by the movement of the shoes 212. There is also advantage in the parallel configuration of the diverting shoes 212 compared to the configuration embodied in FIG. 1 in that there is no reorientation along the angle of diverting, whereby the length of the parcel in the X-X direction is extended, which may cause interference with adjacent parcels as the shoes arrive at line 222. In other embodiments, at the cost of these advantages, but saving equipment cost and complexity, an angled configuration of the diverting shoes 212 may be employed, similar to the embodiment of FIG. 1.

For a given (non-rejected) parcel 208, the number of shoes 212 required to divert the parcel 208 and the timing for actuating the shoes 212 may be determined by the control system 226 based on the length of the parcel and the parcel gapping. The parcel length and gapping may be dimensioned by a sensor, such as a single dimensional photo eye, a 2D or a 3D camera, among others. The parcel dimensioning sensor may be incorporated, for example, in the upstream singulation device 204, or at any other suitable location. The upstream singulation device 204 may also comprise means to identify and flag rejected parcels, to ensure that the shoes 212 are not actuated to divert those parcels.

A first transition conveyor belt 218 may be provided for transitioning parcels 208 from the upstream singulation device 204 to the merge and align conveyor 202, and a second transition conveyor belt 220 may be provided for transitioning parcels 208 from the merge and align conveyor 202 to the takeaway conveyor 206 and the reject conveyor 224. The transition conveyor belts 218, 220 are powered belts which may serve to close gaps created because of sorter sprocket circumference. The transition conveyor belts 218, 220 may include, for example, knife-edge conveyor belts.

The width W1 of the merge and align conveyor 202 is greater than or equal to the sum of the width W2 of the upstream singulation device 204 and the width W3 of the takeaway conveyor 206. The width W 4 of the reject conveyor 224 may be substantially equal to the width of the width W2 of the upstream singulation device 204. The widths W1, W2, W3 and W4 are measured along the Y-axis.

As in embodiment of FIG. 1, the ability to handle small gaps between the parcels 208 out of the upstream singulation device 204 may increase with decreasing link element width. Furthermore, the length (X dimension) of the merge and align conveyor 202 may be determined based on the width W3 of the takeaway conveyor 206 and on the lengths (X dimension) of the transition conveyor belts 218, 220.

The embodiments described in FIGS. 1 and 2 realize a number of common beneficial features.

First, since parcels travel on top of link elements and not rollers, the gap between parcels, as set by the upstream singulation device 104, 204, is largely maintained in the proposed merge and align conveyor 102, 202, as opposed to roller merge and align conveyors. This allows for the upstream singulation device 104, 204 to run at higher efficiency because there is no need to compensate for merge/aligner inefficiencies by introducing additional gaps between parcels out of upstream singulation device 104, 204.

Moreover, the proposed merge and align conveyor 102, 202 is much more tolerant to parcels with uneven shape, size, weight, friction etc. in comparison to roller merge and align conveyors.

Furthermore, the proposed design makes it possible for parcel tracking starting at the upstream singulation device 104, 204, since distance traveled by parcels through the merge and align conveyor 102, 202 at any given time is deterministic (function of speed and time) as compared to roller merge and align conveyors, where distance traveled by parcel at any given time is not deterministic.

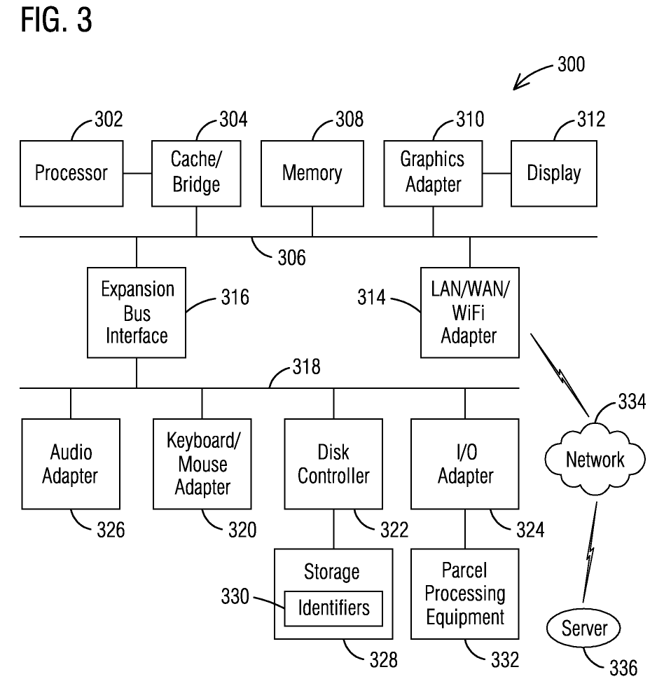

FIG. 3 illustrates a block diagram of a data processing system 300 with which an embodiment can be implemented, for example as part of the control systems 126, 226 or other device configured by software or otherwise to perform the processes as described herein, and in particular as each one of a plurality of interconnected and communicating systems as described herein. The data processing system 300 depicted includes a processor 302 connected to a level two cache/bridge 304, which is connected in turn to a local system bus 306. Local system bus 306 may be, for example, a peripheral component interconnect (PCI) architecture bus. Also connected to local system bus 306 in the depicted example are a main memory 308 and a graphics adapter 310. The graphics adapter 310 may be connected to display 312.

Other peripherals, such as a LAN/WAN/Wireless adapter 314, may also be connected to local system I/O bus 318. Expansion bus interface 316 connects local system bus 306 to input/output (I/O) bus 318. I/O bus 318 is connected to keyboard/mouse adapter 320, disk controller 322, and I/O adapter 324. Disk controller 322 can be connected to a storage 328, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 328 can store any data or executable instructions useful in performing processes as described herein, including in particular the identifiers 330 discussed above.

I/O adapter 324 is connected to control parcel processing equipment 332, which can be any of the elements illustrated in FIGS. 1 and 2.

Also connected to I/O bus 318 in the example shown is audio adapter 326, to which speakers (not shown) may be connected for playing sounds. Keyboard/mouse adapter 320 provides a connection for a pointing device (not shown), such as a mouse, trackball, trackpointer, touchscreen, etc.

Those of ordinary skill in the art will appreciate that the hardware depicted in FIG. 3 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 314 can be connected to a network 334 (not a part of data processing system 300), which can be any public or private data processing system network or combination of networks, as known to those of skill in the art, including the Internet. Data processing system 300 can communicate over network 334 with server system 336, which is also not part of data processing system 300, but can be implemented, for example, as a separate data processing system 300.

Those skilled in the art will recognize that, for simplicity and clarity, the full structure and operation of all systems suitable for use with the present disclosure is not being depicted or described herein. Instead, only so much of the physical systems as is unique to the present disclosure or necessary for an understanding of the present disclosure is depicted and described. The remainder of the construction and operation of the systems disclosed herein may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

The system and processes of the figures are not exclusive. Other systems and processes may be derived in accordance with the principles of the disclosure to accomplish the same objectives. Although this disclosure has been described with reference to particular embodiments, it is to be understood that the embodiments and variations shown and described herein are for illustration purposes only. Modifications to the current design may be implemented by those skilled in the art, without departing from the scope of the disclosure.

1. A parcel processing system comprising:
a merge and align conveyor configured to transport parcels received at an input end to a discharge end of the merge and align conveyor,
the merge and align conveyor comprising:
a support surface for conveying the parcels, the support surface formed by a plurality of successively arranged link elements configured to be driven along a conveying direction from the input end to the output end, the link elements extending longitudinally transverse to the conveying direction, and
a plurality of shoes, each shoe mounted individually on a respective link element and configured to be moved longitudinally along the respective link element while being moved in the conveying direction together with the respective link element the shoes being independently controllable to divert at least a subset of the parcels received at the input end transversely to the conveying direction and stop at a fixed line between opposite edges of the merge and align conveyor whereby a substantially single file parcel flow exiting the discharge end of the merge and align conveyor is obtained along the fixed line.

2. The parcel processing system according to claim 1, further comprising a takeaway conveyor positioned at the discharge end of the merge and align conveyor such that the fixed line is located within a width of the takeaway conveyor the width of the takeaway conveyor being lesser than the width of the merge and align conveyor.

3. The parcel processing system according to claim 1, further comprising a singulation device providing a singulated parcel flow with metered gapping along the conveying direction at the input end of the merge and align conveyor.

4. The parcel processing system according to claim 2, wherein the shoes are controllable to divert each parcel received at the input end of the merge and align conveyor to the fixed line, whereby each parcel transported by the merge and align conveyor is received at the discharge end by the takeaway conveyor.

5. The parcel processing system according to claim 4, wherein the width of the merge and align conveyor is greater than or equal to the width of the singulation device.

6. The parcel processing system according to claim 4, wherein the shoes are arranged in an angled configuration, wherein multiple shoes are arranged at various positions along the length of the respective link elements such that a line of shoes makes an angle to the conveying direction.

7. The parcel processing system according to claim 2, wherein:
the shoes are controllable to selectively divert only those parcels that are identified as “regular” parcels to the fixed line, and to allow parcels identified as “rejected” parcels to be transported un-diverted to the discharge end of the merge and align conveyor, whereby only the “regular” parcels are received in a single file by the takeaway conveyor, and
a reject conveyor is positioned at the discharge end of the merge and align conveyor to receive the “rejected” parcels.

8. The parcel processing system according to claims 7, wherein the width of the merge and align conveyor is greater than or equal to the sum of the width of the singulation device and the width of the takeaway conveyor, and wherein the width of the reject conveyor is substantially equal to the width of the singulation device.

9. The parcel processing system according to claim 7, wherein the shoes are arranged in a parallel configuration, wherein the shoes on respective link elements are arranged along an edge of the merge and align conveyor such that a line of shoes is parallel to the conveying direction.

10. The parcel processing system according to claim 1, wherein the shoes are controllable to stop precisely at the fixed line with their respective push-faces along a straight line, ensuring that a parcel being diverted is oriented by length along the fixed line.

11. A parcel processing method comprising:
receiving parcels at an input end of a merge and align conveyor
transporting parcels on the merge and align conveyor from the input end to a discharge end thereof, the merge and align conveyor comprising a support surface for conveying the parcels the support surface formed by a plurality of successively arranged link elements configured to be driven along a conveying direction from the input end to the output end, the link elements extending longitudinally transverse to the conveying direction, and
diverting at least a subset of the parcels received at the input end transversely to the conveying direction by a plurality of shoes each shoe mounted individually on a respective link element and configured to be moved longitudinally along the respective link element while being moved in the conveying direction together with the respective link element,
wherein diverting the shoes comprises independently controlling each shoe to divert said at least a subset of the parcels received at the input end transversely to the conveying direction and stop at a fixed line between opposite edges of the merge and align conveyor, whereby a substantially single file parcel flow exiting the discharge end of the merge and align conveyor is obtained along the fixed line.

12. The method according to claim 11, further comprising receiving the single file parcel flow exiting the discharge end in a takeaway conveyor , the takeaway conveyor being positioned at the discharge end of the merge and align conveyor such that the fixed line is located within a width of the takeaway conveyor, the width of the takeaway conveyor being lesser than the width of the merge and align conveyor.

13. The method according to claim 11, further comprising operating a singulation device to provide a singulated parcel flow with metered gapping along the conveying direction at the input end of the merge and align conveyor.

14. The method according to claim 12, comprising controlling the shoes to divert each parcel received at the input end of the merge and align conveyor to the fixed line, whereby each parcel transported by the merge and align conveyor is received at the discharge end by the takeaway conveyor .

15. The method according to claim 14, wherein the width of the merge and align conveyor is greater than or equal to the width of the singulation device.

16. The method according to claim 14, comprising arranging the shoes in an angled configuration, wherein multiple shoes are arranged at various positions along the length of the respective link elements such that a line of shoes makes an angle to the conveying direction.

17. The method according to claim 12, comprising:
controlling the shoes to selectively divert only those parcels that are identified as “regular” parcels to the fixed line, and to allow parcels identified as “rejected” parcels to be transported un-diverted to the discharge end of the merge and align conveyor, whereby only the “regular” parcels are received in a single file by the takeaway conveyor, and
receiving the “rejected” parcels by a reject conveyor positioned at the discharge end of the merge and align conveyor.

18. The method according to claims 17, wherein the width of the merge and align conveyor is greater than or equal to the sum of the width of the singulation device and the width of the takeaway conveyor, and wherein the width of the reject conveyor is substantially equal to the width of the singulation device.

19. The method according to claim 17, comprising arranging the shoes in a parallel configuration, wherein the shoes on respective link elements are arranged along an edge of the merge and align conveyor such that a line of shoes is parallel to the conveying direction.

20. The method according to claim 11, comprising controlling the shoes to stop precisely at the fixed line with their respective push-faces along a straight line, ensuring that a parcel being diverted is oriented by length along the fixed line.
